(19) United States
(12) Patent Application Publication
(10) Pub. No.: US 2013/0028257 A1
(43) Pub. Date: Jan. 31, 2013

(54) Message Gateway and Methods for Using the Same

(71) Applicant: Robert C. Ludwick, Fort Wayne, IN (US)

(72) Inventor: Robert C. Ludwick, Fort Wayne, IN (US)

(73) Assignee: RAYTHEON COMPANY, Waltham, MA (US)

(21) Appl. No.: 13/192,272

(22) Filed: Jul. 27, 2011

(51) Int. Cl. H04L 12/56

(52) U.S. Cl. 370/392; 370/401

(57) ABSTRACT

A computer-implemented method for transporting a message includes receiving the message from a first application via a first communication protocol, the first message including data indicating a destination for the message, generating a gateway address from the data indicating the destination, a gateway associated with the gateway address being accessible by the destination, and transporting the message to the gateway according to the gateway address using a second communication protocol, in which the first and second communication protocols are different, and in which the second communication protocol is a disruption-tolerant networking protocol.

### FIELD OF THE INVENTION

This disclosure relates in general to sending messages across a network and, more specifically, to sending messages using a disruption tolerant network.

### BACKGROUND

Military applications currently use TCP/IP protocols to send messages on and off the battlefield. In one specific example, a soldier in battle may send a “fire control” message to other troops to request an air strike on a particular location or facility. Such fire control message may conform to a VMF 6017Amessage structure, where the VMF 6017Amessage includes a data payload and a header that may provide a source and/or destination address. The VMF 6017Amessage may be encapsulated into one or more TCP/IP packets and sent to a destination.

Some military applications, especially those deployed in rugged or remote locations, may experience periods lacking network connectivity. For instance, soldiers may be in a canyon or a valley that is so deep that the soldiers' devices cannot see a communication tower. TCP does not provide a robust mechanism for handling prolonged periods without connectivity.

However, some work has been done to develop communication protocols that are “disruption tolerant.” For instance, Delay-Tolerant Networking and Disruption-Tolerant Networking (both DTN) are terms of art used to describe networking protocols that handle disruption and delay by storing bundles of data and then sending the bundles during times when connectivity is available (or at least expected to be available). Defense Advanced Research Projects Agency (DARPA) is developing a networking protocol referred to as DTN, described in RFC 4888 and RFC 5050. While DTN is useful in some applications, it has its own protocol stack separate and different from that used by TCP/IP. There is currently no simple upgrade path from applications and networks relying TCP/IP to one that is Disruption Tolerant. Without a simple upgrade, drastic modifications to software might be used for applications to take advantage of the disruption tolerant capabilities of the new network.

### SUMMARY

According to one embodiment, a computer-implemented method for transporting a message includes receiving the message from a first application via a first communication protocol, the first message including data indicating a destination for the message, generating a gateway address from the data indicating the destination, a gateway associated with the gateway address being accessible by the destination, and transporting the message to the gateway according to the gateway address using a second communication protocol, in which the first and second communication protocols are different, and in which the second communication protocol is a disruption-tolerant networking protocol.

According to another embodiment, a computer-implemented method for sending a message to a destination application includes receiving a message for the destination application from a gateway, the message being received using a first communication protocol that is disruption-tolerant, the message including address data for the destination, generating an address for the destination application according to a second communication protocol from the address data, in which the address data does not conform to either the first or the second communication protocols, and sending the message to the destination application using the second communication protocol.

According to yet another embodiment, a network device includes a communication port receiving a message for a destination application by a first communication protocol, the message including address data for the destination application in which the address data does not conform to the first communication protocol, an address generator using the address data to generate an address for a network gateway according to a second communication protocol that is disruption-tolerant, and a transmitting unit sending the message to the network gateway using the second communication protocol.

### BRIEF DESCRIPTION OF THE DRAWINGS

A better understanding of the present invention will be realized from the detailed description that follows, taken in conjunction with the accompanying drawings, in which:

FIG. 1 is an illustration of an exemplary system for providing messages across a delay-tolerant network, according to one embodiment.

FIG. 2 is an illustration of an exemplary packet that may be transmitted on a TCP/IP network.

FIG. 3 is an illustration of an exemplary packet that may be transmitted over DTN.

FIGS. 4 and 5 illustrate a method for sending a message from a first application to a second application over a DTN adapted according to one embodiment.

### DETAILED DESCRIPTION

Various embodiments provide techniques to send and receive messages within a network that experiences delays or disruptions. One specific example involves TCP/IP applications that use DTN gateways to communicate with each other. However, the scope of embodiments is not limited to TCP/IP and DTN. Rather, any technique that uses a disruption-tolerant protocol to communicate between applications using a different (and possibly not disruption-tolerant) protocol may be used by different embodiments.

In this example embodiment, a software gateway allows the receipt and retransmission of messages through DTN. The gateway receives the messages via the User Datagram Protocol (UDP) or Transport Control Protocol (TCP) and decodes the recipient information. A particular recipient is mapped into a DTN endpoint uniform resource indicator(URI), and then transmitted through the DTN Bundling Protocol (BP). At the DTN endpoint, the gateway encodes the message according to the message's original transport protocol and forwards the message to the recipient.

Thus, in this example, a message is sent by TCP/IP from a first application (e.g., a handheld radio device, a computer, etc.) to a first DTN gateway. The first DTN gateway strips off the TCP/IP header and looks at the underlying message for a Unit Reference Number (URN) of the desired destination. The first DTN gateway then places the underlying message in a DTN packet that includes a destination address of a second DTN gateway that is accessible to the desired destination.

The first DTN gateway sends the packet or packets to the second DTN gateway using DTN transport. The second DTN gateway pulls of the DTN header and constructs one or more TCP/IP datagrams, which contain the underlying message, to send to the desired destination. In doing so, the second DTN gateway looks at the URN in the underlying message to generate a destination IP address.

In this example, the functionality of the gateways and the endpoints are symmetrical. Thus, when the destination replies to the source with an acknowledgment message, the same processes are used to transport the acknowledgement message back to the originating application. In some embodiments, the use of the gateways to transmit messages through DTN increases the robustness and reliability of the message transfer without requiring changes to the end applications.

Various embodiments further include one or more processor-based devices to implement the process discussed above. For instance, some embodiments of an endpoint device or a gateway include a processor that executes computer code to perform the functions that make up the message transfer technique. Other embodiments may be implemented in hardware or a combination of hardware and software.

Some implementations may be applicable to military applications, though the scope of embodiments is not so limited. Some embodiments include systems and methods that are deployed for space communication or commercial, industrial, or consumer applications.

The above-identified example embodiments are for illustration purposes only, and the scope of embodiments is not limited to the details described above. The following figures are used to describe example embodiments in more detail.

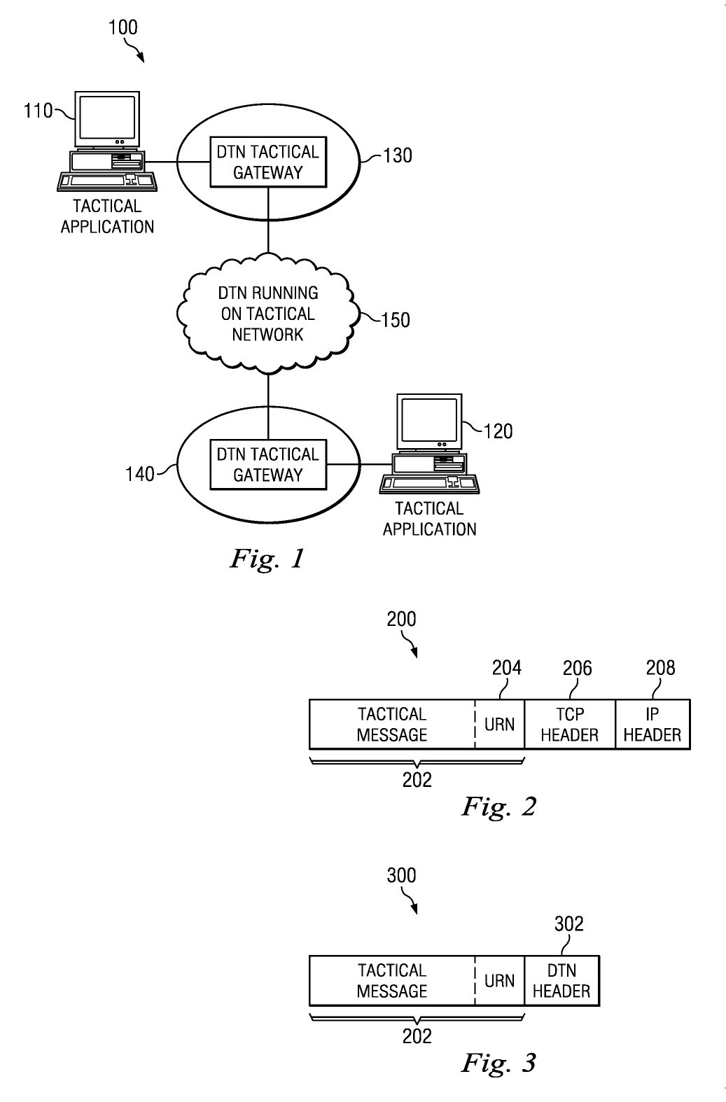

FIG. 1 is an illustration of exemplary system 100, adapted according to one embodiment. The various components of system 100 may be implemented as hardware and/or software modules that execute computer-readable code (e.g., software or firmware) providing functionality described herein. The example of system 100 is in the context of a military tactical message path. However, it is noted that the scope of embodiments is not limited to military application or even to tactical messages. Various embodiments may be adapted for use in any application with any type of message, though the use of DTN may find special utility in military and space applications.

Tactical application 110 is shown as being associated with a personal computer, but in other embodiments tactical application 110 may be associated with a hand-held radio unit, a rack-mounted server computer, or other network communication device. Tactical application 110 in this example is a computer program executed by a network communication device that allows for the sending and receiving of messages.

In one instance, tactical application 110 may be used to send and receive tactical messages, such as those according to VMF 6017A. However, other messaging techniques may be used, such as JBMF, Package 10, Package 11, and the like. When tactical application 110 is used to send a message, the data is accumulated in a send buffer with other data, such as communication overhead data. One example of communication overhead data includes a header portion that indicates a destination for the message. VMF 6017Aincludes a 47001C header that can be used to indicate a Unit Reference Number (URN) for the destination, where the URN conforms to VMF 6017Arather than to TCP/IP, UDP/IP, or DTN.

Tactical application 110 in this example is an IP application that uses either TCP or UDP for transport of messages. TCP and UDP are both different from DTN, having different stacks, and in general, TCP and UDP are not used with DTN.

From the point of view of tactical application 110, it is sending a TCP/IP packet (or packets) to tactical application 120, which is also an IP application. However, there is no IP network connectivity between applications 110 and 120. Accordingly, network 150 runs DTN, which is tolerant of delays and undependable connectivity. In some instances, tactical application 110 does not know the IP address of tactical application 120, in which case, tactical application 110 addresses the IP datagram with the message to the IP address of gateway 130.

Gateway 130 has IP network connectivity with tactical application 110, and gateway 130 receives the message sent by tactical application 110 using TCP/IP or UDP/IP. FIG. 2 shows an example data packet 200 that is sent by tactical application 110 and received by gateway 130. Tactical message 202 forms the data payload, and it includes a 47001C header 204, which has a URN of the second tactical application 120. The URN may include an alpha-numeric string that uniquely identifies the destination application 120 in a tactical message system. Message 202 is formed into a TCP segment by the addition of TCP (or UDP) header 206. The TCP segment is encapsulated into an IP datagram by addition of IP header 208.

Returning to FIG. 1, tactical application 110 sends the data packet 200 over the IP network, where it is received by gateway 130. Gateway 130 strips the message of headers 206, 208 and maps the URN into a DTN namespace. In this example, tactical application 110 is unaware of the DTN network and does not include any DTN address data in the message. Furthermore, tactical application 120 is not directly accessible by gateway 130, so that gateway 130 sends the message to gateway 140. When gateway 130 maps the URN to a DTN namespace, it may use a lookup table or other algorithm to generate the DTN address of gateway 140. And in instances where there are multiple gateways (not shown) in the DTN network, gateway 140 may be chosen as a closest gateway to tactical application 120.

The embodiment shown in FIG. 1 is somewhat simplified for ease of illustration, but it is understood that other embodiments may have a more complicated topology. For instance, tactical application 110 may be connected over an IP network to multiple other gateways (not shown), and the same is true of tactical application 120. Furthermore, gateways 130, 140 may each be connected by an IP network to multiple other tactical applications (not shown). Also, tactical network 150 may include more hops than are shown in FIG. 1, so that a message may be routed through multiple DTN devices between gateways 130, 140.

FIG. 3 is an illustration of exemplary DTN packet 300. Gateway 130 receives packet 200 (FIG. 2) and strips TCP and IP headers 206, 208. After gateway 130 maps the URN to a DTN namespace, it generates packet 300, which includes the original message 202 plus DTN overhead data shown as DTN header 302.

Returning to FIG. 1, gateway 130 sends packet 300 to gateway 140 over tactical network 150 that runs DTN. In other words, the packet 300 is sent over network 150 using DTN for transport, and packet 300 traverses as many hops and experiences as many delays as are necessary to make it to gateway 140 according to network conditions at that time. DTN uses store and forward and Bundling Protocol (BP) to deliver packet 300 to gateway 140. In some instances, delivery of the message may be very quick, whereas in other instances, delays and intermittent connectivity may lengthen the time it takes to deliver the message.

When gateway 140 receives packet 300, it removes header 302 and looks at the URN in message 202. Gateway 140 maps the URN to an IP address of tactical application 120 using a look-up table or other algorithm. Gateway 140 then re-encodes message 202 as an IP datagram (such as shown in FIG. 2) with the IP address of tactical application 120 in the IP header. The IP datagram then traverses an IP network to be delivered to tactical application 120.

Upon receipt of the message, tactical application 120 may remove the TCP/IP overhead data and look at the contents of the message 202. Furthermore, tactical application 120 may send an acknowledgement message back to tactical application 110, where the acknowledgement message is handled in the same manner as the original message (going from IP to DTN and back to IP). However, because of the changing nature of IP and DTN networks, the acknowledgement message may or may not traverse the exact path as the original message.

The system of FIG. 1 may include additional features. For instance, while DTN may transmit any message of any arbitrary size, an IP network may specify that datagrams should have a maximum size. Accordingly, in some embodiments, gateways 130, 140 provide for segmentation and reassembly of packets in order to comply with size requirements of IP and efficiency goals of DTN.

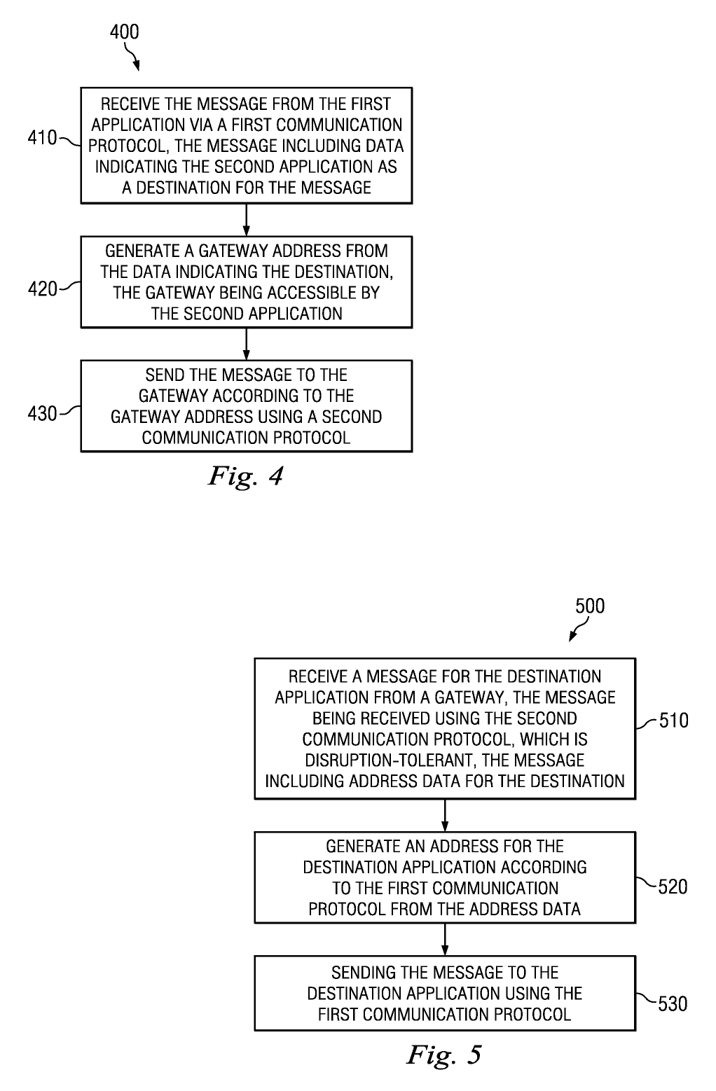

FIG. 4 is an illustration of exemplary process 400 adapted according to one embodiment for providing communication between two different applications (e.g., applications 110 and 120 of FIG. 1). Process 400 may be performed by a gateway, such as either of gateways 130, 140 of FIG. 1. The following example refers to a first communication protocol and a second communication protocol, where the first and second communication protocols are different. For instance, the first communication protocol may include any network communication protocol, with TCP/IP and UDP/IP being only two examples. Another example includes MLSTD 4700C. The second communication protocol is a disruption-tolerant protocol, such as DTN, though any disruption-tolerant protocol now known or later developed may be used in various embodiments.

At block 410, a first gateway receives the message from the first application via the first communication protocol. For instance, as shown in FIG. 1, the first gateway may receive a message from an application that communicates over a first type of network. Further in block 410, the message includes data indicating a second application as a destination. In some instances, the data may not conform to either the first or the second communication protocols (e.g., such as a 47001C header with a URN that does not conform to a proper address string in TCP, UDP, or DTN).

At block 420, the first gateway generates a gateway address from the address data in the message. For instance, in some examples, the first gateway generates a DTN endpoint address that happens to be associated with a second gateway that is accessible by the second application (the destination of the message). Block 420 may use any technique to generate a gateway address from the address data in the original message. One example includes the use of a look-up table that maps destinations to associated gateways, though any appropriate technique may be used.

At block 430, the first gateway sends the message to the second gateway according to the generated gateway address. Thus, the generated gateway address may indicate an endpoint in a second network, where the message is sent using a second communication protocol.

FIG. 5 is an illustration of exemplary method 500, adapted according to one embodiment for providing communication between two different applications. Process 500 may be performed by a gateway, such as either of gateways 130, 140 of FIG. 1. The process illustrated in FIG. 5 builds upon the example of FIG. 4. Specifically, FIG. 4 describes actions that may be performed by gateway 130 to forward the message from application 110 to gateway 130. FIG. 5 provides example actions that may be performed by gateway 140 to forward the message to application 120.

At block 510, the message is received by the second gateway from the first gateway, where the message is sent and received between the first and second gateways using the second communication protocol. As mentioned above, the second communication protocol is disruption-tolerant. In some instances, block 510 includes the message traversing multiple hops between the first and second gateways.

At block 520, the second gateway generates an address for the destination application according to the first communication protocol. For instance, the second gateway may use the address data in the original message (e.g., a URN of the destination) to generate a network address for the destination according to the first communication protocol.

At block 530, the second gateway sends the message to the destination application using the first communication protocol.

The scope of embodiments is not limited to the examples of FIGS. 4 and 5. For instance, other embodiments may add, omit, rearrange, or modify actions. In one example, the method of FIG. 5 further includes the destination application sending an acknowledgement message back to the originating application. Furthermore, the actions of blocks 410 and 530 may include the message being routed through multiple hops according to the first network protocol.

The gateways 130, 140 of FIG. 1 are systems that include communication ports for receiving messages for a destination application by a first communication protocol and for sending the messages to a network endpoint according to a second communication protocol. Gateways 130, 140 also include address generators for generating an address in the delay-tolerant network from a URN and for generating an address in the first network (e.g., an IP network) using the URN. Gateways 130, 140 also include transmitting/receiving units coupled with the communication ports to send and receive the messages according to the first and second communication protocols.

Any particular hardware configuration may be used in some embodiments. One embodiment includes a hand-held radio that generates tactical messages according to VMF 6017A. A functional module associated with the radio encapsulates the tactical message as an IP datagram. A DTN gateway may also be associated with the radio or may be a remote device that communicates with the radio. For instance, the DTN gateway may be configured as a land-based radio base station or may be configured as a radio device that is included in an aerial vehicle that passes over a strategic location. In any event, the DTN gateway receives the IP datagrams and forwards them over a DTN connection, as described above, to another DTN gateway.

It is understood that some embodiments are implemented in computer executable code (e.g., software, firmware), that is run by a processor device. One embodiment includes a hand-held communication device (e.g., radio, a smartphone, or the like), whereas another embodiment may be run on a special-purpose or general-purpose computer that has appropriate network interfaces to communicate with at least two different networks.

When implemented via computer-executable instructions, various elements of some embodiments are in essence the software or firmware code defining the operations of such various elements. The executable instructions or code may be obtained from a tangible readable medium (e.g., a hard drive media, optical media, RAM, EPROM, EEPROM, tape media, cartridge media, flash memory, ROM, memory stick, network storage device, and/or the like). In fact, readable media can include any medium that can store information.

The processing unit may include, for example, a general purpose CPU, which may execute the various logical instructions according to embodiments of the present disclosure. For example, one or more CPUs may execute machine-level instructions according to the exemplary operational flows described above in conjunction with FIGS. 4 and 5. Moreover, embodiments of the present disclosure may be implemented on application specific integrated circuits (ASICs) digital signal processors (DSPs), or other specialized processing circuits. In fact, persons of ordinary skill in the art may utilize any number of suitable structures capable of executing logical operations according to the embodiments of the present disclosure.

Various embodiments include one or more advantages. For instance, some implementations provide a way to adapt IP messages to a DTN system. Further, some embodiments may provide gateways that require little or no modification of legacy IP applications, since the gateways are capable of sending and receiving IP messages to endpoint applications.

Although selected embodiments have been illustrated and described in detail, it should be understood that a variety of substitutions and alterations are possible without departing from the spirit and scope of the present invention, as defined by the claims that follow.

What is claimed is:

1. A computer-implemented method for transporting a message, the method comprising:
receiving the message from a first application via a first communication protocol, the first message including data indicating a destination for the message;
generating a gateway address from the data indicating the destination, a gateway associated with the gateway address being accessible by the destination; and
transporting the message to the gateway according to the gateway address using a second communication protocol;
in which the first and second communication protocols are different, and in which the second communication protocol is a disruption-tolerant networking protocol.

2. The method according to claim 1, in which the first communication protocol includes User Datagram Protocol (UDP).

3. The method according to claim 1, in which the first communication protocol includes Transmission Control Protocol (TCP).

4. The method according to claim 1, in which the data indicating a destination is a unit reference number for the destination, further in which the unit reference number is not a destination indicator for the first communication protocol.

5. The method according to claim 1, in which transporting the message comprises:
removing a first header from the message, the first header associated with the first communication protocol; and
generating a second header for the message, the second header associated with the second communication protocol.

6. The method according to claim 1 in which transporting the message to the gateway includes sending the message using a bundling protocol associated with the second communication protocol.

7. The method according to claim 1 in which generating a gateway address comprises:
using a look-up table to access the gateway address from the data indicating a destination.

8. The method according to claim 1, further comprising:
receiving an acknowledgement message by the second communication protocol from the destination via the gateway; and
sending the acknowledgement message to the first application using the first communication protocol.

9. A computer-implemented method for sending a message to a destination application, the method comprising:
receiving a message for the destination application from a gateway, the message being received using a first communication protocol that is disruption-tolerant, the message including address data for the destination;
generating an address for the destination application according to a second communication protocol from the address data, in which the address data does not conform to either the first or the second communication protocols; and
sending the message to the destination application using the second communication protocol.

10. The method according to claim 9 in which the address data comprises a unit reference number for the destination application and in which generating an address for the destination application comprises:
generating an Internet Protocol (IP) address for the destination application.

11. The method according to claim 9 in which receiving the message comprises:
removing a first header associated with the first communication protocol, and further in which sending the message comprises:
attaching a second header to the message, the header conforming to the second communication protocol.

12. A network device comprising:
a communication port receiving a message for a destination application by a first communication protocol, the message including address data for the destination application in which the address data does not conform to the first communication protocol;
an address generator using the address data to generate an address for a network gateway according to a second communication protocol that is disruption-tolerant; and
a transmitting unit sending the message to the network gateway using the second communication protocol.

13. The network device of claim 12 in which the address generator generates a Disruption-Tolerant Network (DTN) address from a unit reference number of the destination application.

14. The network device of claim 12 in which the first communication protocol comprises one of User Datagram Protocol (UDP) and Transmission Control Protocol (TCP).

15. The network device of claim 12 in which the communication port removes a first header associated with the first communication protocol from the message and further in which the transmitting unit attaches a second header associated with the second communication protocol to the message.

16. A computer program product having a computer readable medium tangibly recording computer program logic for transmitting a message from a first application to a second application, the computer program product comprising:
code to receive the message from the first application via a first communication protocol, the message including data indicating the second application as a destination for the message;
code to generate a gateway address from the data indicating the destination, a gateway associated with the gateway address being accessible by the second application; and
code to send the message to the gateway according to the gateway address using a second communication protocol;
in which the first and second communication protocols are different, and in which the second communication protocol is a disruption-tolerant networking protocol.

17. The computer program product of claim 16 in which the data indicating the second application includes a unit reference number for the second application that does not conform to the first or second communication protocols.

18. The computer program product of claim 16 in which the code to receive the message comprises:
code to remove a first header from the message, further in which the code to send the message comprises:
code to attach a second header to the message.

19. The computer program product of claim 16 in which the code to send the message to the gateway comprises:
code to send the message using a bundling protocol associated with the second communication protocol.

20. The computer program product of claim 16, further comprising:
code to receive an acknowledgement message from the second application via the gateway using the second communication protocol; and
code to send the acknowledgement message to the first application using the first communication protocol.
